(19) United States
(12) Patent Application Publication
(10) Pub. No.: US 2014/0355906 A1
(43) Pub. Date: Dec. 4, 2014

(54) IMAGE EDITING APPARATUS, IMAGE EDITING METHOD, AND NON-TRANSITORY STORAGE MEDIUM

(71) Applicant: FUJIFILM CORPORATION, Tokyo (JP)

(72) Inventors: Masashi KURANOSHITA, Minato-ku (JP); Eiji TERAUE, Minato-ku (JP); Yoshiaki KINOSHITA, Minato-ku (JP)

(73) Assignee: FUJIFILM CORPORATION, Tokyo (JP)

(21) Appl. No.: 14/288,581

(22) Filed: May 28, 2014

(30) Foreign Application Priority Data
May 31, 2013 (JP) 2013-114836

(51) Int. Cl. G06F 3/12; G06K 15/02; G06T 11/60

(52) U.S. Cl. CPC G06F 3/1206; G06T 11/60; G06K 15/02
USPC 382/284

(57) ABSTRACT

A first object cluster is generated by laying out a greatest number of objects along an arraying direction such that the objects do not exceed the length of one side of the imposition area which is set, based on the profile shape of the objects. A greatest number of first object clusters are placed along a direction of another side, extending across the one side, of the imposition area such that the first object clusters do not exceed the length of the other side, based on the shape of the first object cluster.

### CROSS-REFERENCE TO RELATED APPLICATION

This application is based upon and claims the benefit of priority from Japanese Patent Application No. 2013-114836 filed on May 31, 2013, the contents of which are incorporated herein by reference.

### BACKGROUND OF THE INVENTION

1. Field of the Invention

The present invention relates to an image editing apparatus, an image editing method, and a non-transitory storage medium for ganging objects of one type in non-overlapping positions on a printing plate or a print medium.

2. Description of the Related Art

Heretofore, there has been known in the platemaking field a package printing process for ganging objects of a certain type, e.g., the development of a package, on a single print sheet (multiple imposition). Various techniques have been proposed in the art to lay out objects efficiently in non-overlapping positions.

Japanese Laid-Open Patent Publication No. 03-273253 discloses a method of and an apparatus for ganging desired images on a photosensitive medium with a step-and-repeat machine. The publication reveals, for example, that a plurality of basic layout patterns each comprising a combination of paired objects, e.g., six development patterns in the illustrated example, are placed complementarily.

According to Japanese Laid-Open Patent Publication No. 06-068211, there is proposed an apparatus for automatically determining an imposed layout in a sheet area by entering various items of information including figure data of objects. The publication states that the various items of information include basic layout patterns, e.g., a vertically reversed complementary pattern, which define combinations of figures according several patterns.

### SUMMARY OF THE INVENTION

Generally, the shapes of objects are designed by professionals such as designers in view of the efficiency with which to lay out the objects. Recently, the printing industry has seen an established environment which allows individuals, rather than professionals, to design objects with relative ease. Stated otherwise, the printers need to tackle the issue of how to gang objects that have been designed with almost no concern about the efficiency with which to lay out the objects.

The apparatus disclosed in Japanese Laid-Open Patent Publication No. 03-273253 and Japanese Laid-Open Patent Publication No. 06-068211 have not taken into account the above problem, and do not guarantee that objects of any shapes can be laid out efficiently.

According to one solution, a known layout optimizing algorithm may be applied to place objects in a two-dimensional close-packed layout. However, the two-dimensional laying-out process requires a long processing time and tends to lower the efficiency of a blanking (die-cutting) process in case the process produces an irregular object layout.

It is an object of the present invention to provide an image editing apparatus, an image editing method, and a non-transitory storage medium which are capable of ganging objects of any shapes efficiently in terms of a layout space, a processing time, and a blanking process.

According to the present invention, there is provided an image editing apparatus for ganging objects of one type in non-overlapping positions on a printing plate or a print medium, comprising a profile shape acquirer for acquiring a profile shape of the objects, a layout condition setter for setting a rectangular imposition area on the printing plate or the print medium, a cluster generator for generating a first object cluster by laying out a greatest number of objects along an arraying direction such that the objects do not exceed a length of one side of the imposition area set by the layout condition setter, based on the profile shape acquired by the profile shape acquirer, and an object placer for placing a greatest number of first object clusters along a direction of another side, extending across the one side, of the imposition area such that the first object clusters do not exceed a length of the other side, based on a shape of the first object cluster generated by the cluster generator.

As described above, the image editing apparatus includes the cluster generator for generating a first object cluster by laying out a greatest number of objects along an arraying direction such that the objects do not exceed the length of one side of the set imposition area, based on the profile shape of the object, and the object placer for placing a greatest number of first object clusters along a direction of another side of the imposition area such that the first object clusters do not exceed the length of the other side, based on a shape of the first object cluster. Therefore, the imposition apparatus is capable of performing a two-dimensional layout process for objects by dividing the two-dimensional layout process into two times of separate one-dimensional layout processes. Consequently, the processing time required to carry out the two-dimensional layout process can greatly be reduced. Furthermore, since the objects are laid out using the first object cluster as a basic unit, the objects that make up the first object cluster have their relative positional relationship and regularity maintained at all times. Therefore, objects which have any desired shape can be ganged efficiently in terms of layout space, processing time, and blanking.

Preferably, the cluster generator generates the first object cluster by uniformly widening an interval along the arraying direction between the objects such that the objects do not exceed the length of the one side, while the greatest number of objects are being placed in a close-packed layout.

Preferably, the cluster generator further generates a second object cluster by deleting an endmost object from the first object cluster, and the object placer lays out the first object cluster and the second object cluster alternately along the direction of the other side.

Preferably, the object placer uses Boolean values assigned to respective cells divided as mesh openings to indicate whether each of the objects to be laid out is present or not, thus generating a binary image, makes a judgment about an overlap between the objects based on the binary image thus generated, and lays out the first object cluster or the second object cluster such that the objects will not overlap each other.

Preferably, the cluster generator uses Boolean values assigned to respective cells divided as mesh openings to indicate whether each of the objects to be laid out is present or not, thus generating a binary image, makes a judgment about an overlap between the objects based on the binary image thus generated, and generates the first object cluster such that the objects will not overlap each other.

Preferably, the layout condition setter sets a limiting condition with respect to an orientation of the objects, and the cluster generator generates the first object cluster according to the limiting condition set by the layout condition setter.

According to the present invention, there is also provided an image editing method of ganging objects of one type in non-overlapping positions on a printing plate or a print medium, comprising the steps of acquiring a profile shape of the objects, setting a rectangular imposition area on the printing plate or the print medium, generating an object cluster by laying out a greatest number of objects along an arraying direction such that the objects do not exceed a length of one side of the imposition area which is set, based on the profile shape which is acquired, and placing a greatest number of first object clusters along a direction of another side, extending across the one side, of the imposition area such that the first object clusters do not exceed a length of the other side, based on a shape of the object cluster which is generated.

Preferably, the step of generating generates the first object cluster by uniformly widening an interval along the arraying direction between the objects such that the objects do not exceed the length of the one side, while the greatest number of objects are being placed in a close-packed layout.

Preferably, the step of generating generates a second object cluster by deleting an endmost object from the first object cluster, and the step of placing lays out the first object cluster and the second object cluster alternately along the direction of the other side.

Preferably, the step of placing uses Boolean values assigned to respective cells divided as mesh openings to indicate whether each of the objects to be laid out is present or not, thus generating a binary image, makes a judgment about an overlap between the objects based on the binary image thus generated, and lays out the first object cluster or the second object cluster such that the objects will not overlap each other.

Preferably, the step of generating uses Boolean values assigned to respective cells divided as mesh openings to indicate whether each of the objects to be laid out is present or not, thus generating a binary image, makes a judgment about an overlap between the objects based on the binary image thus generated, and generates the first object cluster such that the objects will not overlap each other.

Preferably, the step of setting sets a limiting condition with respect to an orientation of the objects, and the step of generating the first object cluster according to the limiting condition which is set.

According to the present invention, there is further provided a non-transitory storage medium storing a program for ganging objects of one type in non-overlapping positions on a printing plate or a print medium, wherein the program controls a computer to perform the steps of acquiring a profile shape of the objects, setting a rectangular imposition area on the printing plate or the print medium, generating an object cluster by laying out a greatest number of objects along an arraying direction such that the objects do not exceed a length of one side of the imposition area which is set, based on the profile shape which is acquired, and placing a greatest number of first object clusters along a direction of another side, extending across the one side, of the imposition area such that the first object clusters do not exceed a length of the other side, based on a shape of the object cluster which is generated.

With the image editing apparatus, the image editing method, and the non-transitory storage medium according to the present invention, as described above, a first object cluster is generated by laying out a greatest number of objects along an arraying direction such that the objects do not exceed the length of one side of the set imposition area, based on the profile shape of the object, and a greatest number of first object clusters are placed along a direction of another side, extending across the one side, of the imposition area such that the first object clusters do not exceed the length of the other side, based on a shape of the first object cluster. Therefore, it is possible to perform a two-dimensional layout process for objects by dividing the two-dimensional layout process into two times of separate one-dimensional layout processes. Consequently, the processing time required to carry out the two-dimensional layout process can greatly be reduced. Furthermore, since the objects are laid out using the first object cluster as a basic unit, the objects that make up the first object cluster have their relative positional relationship and regularity maintained at all times. Therefore, objects which have any desired shape can be ganged efficiently in terms of layout space, processing time, and blanking.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a print production system incorporating an imposing apparatus as an image editing apparatus according to an embodiment of the present invention;

FIG. 2 is a front view of a print shown in FIG. 1;

FIG. 3 is an electric block diagram of the imposing apparatus shown in FIG. 1;

FIG. 4 is a flowchart of an operation sequence of the imposing apparatus shown in FIGS. 1 and 3;

FIG. 5 is a view showing a first image representing a setting screen for an automatic imposing process;

FIG. 6 is a view of an object to be ganged;

FIG. 7 is a detailed flowchart of a process of generating an object cluster (step S6 in FIG. 4);

FIG. 8 is a view showing the positional relationship of an imposition area and a search area;

FIGS. 9A and 9B are views illustrating a process of searching for an object layout;

FIGS. 10A through 10C are views illustrating a process of rendering an object;

FIGS. 11A and 11B are views illustrating a process of judging an object overlap;

FIG. 12A is a view showing the positional relationship of laid-out objects placed in a close-packed layout along an X-axis;

FIG. 12B is a view showing the laid-out objects in FIG. 12A which have been spaced apart at uniformly widened intervals;

FIG. 13A is a front view of a first object cluster;

FIG. 13B is a front view of a second object cluster;

FIGS. 14A and 14B are views illustrating a process of searching for an object cluster layout;

FIG. 15A is a view showing two first object clusters that have been placed in a close-packed layout;

FIG. 15B is a view showing a first object cluster and a second object cluster that have been placed in a close-packed layout;

FIG. 16 is a view showing a second image representing the setting screen for the automatic imposing process;

FIG. 17 is a view showing a third image representing the setting screen for the automatic imposing process;

FIG. 18 is a view showing a fourth image representing the setting screen for the automatic imposing process;

FIG. 19A is a view showing a layout of objects oriented in one direction; and

FIG. 19B is a view showing a layout of objects that have been placed in a close-packed layout by an image processing method according to the embodiment.

### DESCRIPTION OF THE PREFERRED EMBODIMENTS

An image editing method according to a preferred embodiment of the present invention in relation to an image editing apparatus and a non-transitory storage medium that stores an image editing program, for performing the image editing method, will be described in detail below with reference to the accompanying drawings.

### [Overall Arrangement of Print Production System 10]

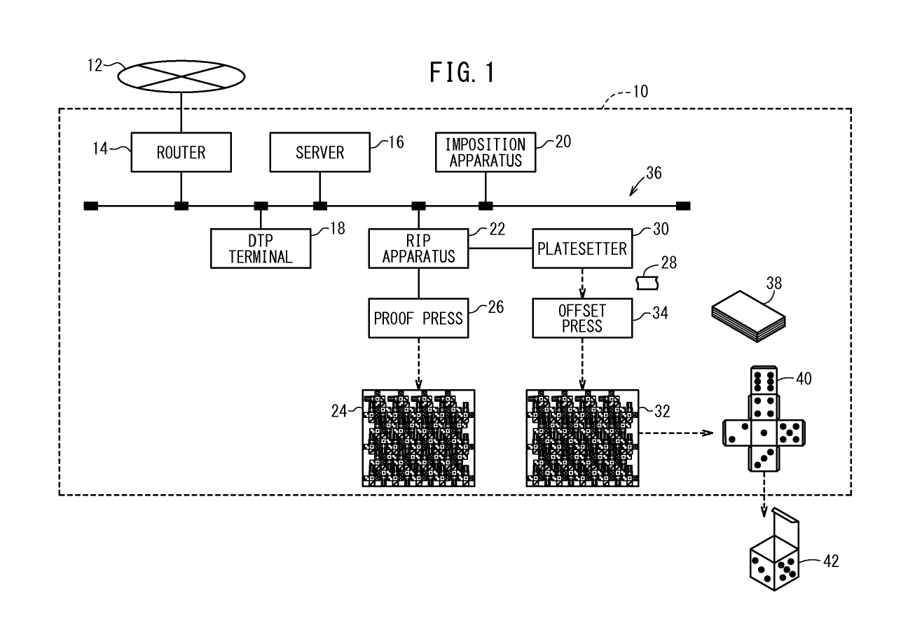

FIG. 1 shows in block form a print production system 10 incorporating an imposition apparatus 20 as an image editing apparatus according to an embodiment of the present invention.

As shown in FIG. 1, the print production system 10 includes a router 14 serving as a device for connection to a network 12, a server 16 which is accessible through the network 12 from terminal devices, not shown, belonging to external networks, a DTP terminal 18 for performing DTP (DeskTop Publishing) process, including an editing process, on contents data acquired from the server 16, etc., an imposition apparatus 20 for imposing contents data processed by the DTP terminal 18, an RIP apparatus 22 for performing various image processing processes including a rasterizing process, a color conversion process, etc. on platemaking data (or printing plate data) imposed by the imposition apparatus 20, a proof press 26 for printing a proof 24 based on proofread data sent from the RIP apparatus 22, a platesetter 30 for producing a printing plate 28 based on the platemaking data sent from the RIP apparatus 22, and an offset press 34 for producing a print 32 with the printing plate 28 set therein.

The server 16 is an apparatus that plays a central role in the workflow management in the print production system 10. The server 16 is connected to various terminal devices at least one of designers and production companies, not shown, for communication therewith through the router 14 and the network 12. The server 16 is also connected to the DTP terminal 18, the imposition apparatus 20, and the RIP apparatus 22 for communication therewith through a LAN (Local Area Network) 36 constructed in the print production system 10.

Specifically, the server 16 is capable of performing a function as a file server for storing and transferring various data files, a function as an authorization management server for managing task authorizations that are available for terminals, users or print jobs, and a function as a mail server for generating and distributing notification mails at certain times such as process starting and ending times. The data files that can be managed by the server 16 as the file server include contents data, proof data, platemaking data, job ticket files {e.g., JDF (Job Definition Format) files}, ICC (International Color Consortium) profiles, color sample data, etc.

The DTP terminal 18 generates image data per page (hereinafter also referred to as “page image”) from contents data representing characters, figures, patterns, pictures, etc. which have been processed by a preflight process. The imposition apparatus 20 performs an imposing process according to a binding process and a page folding process which have been designated, by referring to the tag information of a job ticket.

The RIP apparatus 22 functions as a printing processing server for at least one type of printing press. In FIG. 1, the RIP apparatus 22 is connected to the proof press 26 and the platesetter 30 for communication therewith. The RIP apparatus 22 converts data expressed in a page description language (PDL) (hereinafter referred to as “page description data”) into print data suitable for printing presses, and supplies the print data to the proof press 26 or the platesetter 30.

The proof press 26 prints a proof 24 based on the print data supplied from the RIP apparatus 22. The proof press 26 may comprise a DDCP (Direct Digital Color Proofer), an ink jet color proofer, a low-resolution color laser printer (electrophotographic printer), an ink jet printer, or the like.

The offset press 34 produces a print 32 which has images printed on a sheet 38 (print medium) by applying inks to the main surface of the sheet 38 through printing plates 28 and intermediate transfer members, not shown. The offset press 34 may be replaced with a digital printing press for direct printing. The digital printing press may comprise an ink jet printing press, a wide-format printing press, an ink jet color proofer, a color laser printer (electrophotographic printer), or the like.

Thereafter, a number of package blanks 40 (see FIG. 1) which are identical in shape to each other are blanked out of the print 32. Each of the package blanks 40 is folded, put together, and pasted into an assembled cube-shaped package 42.

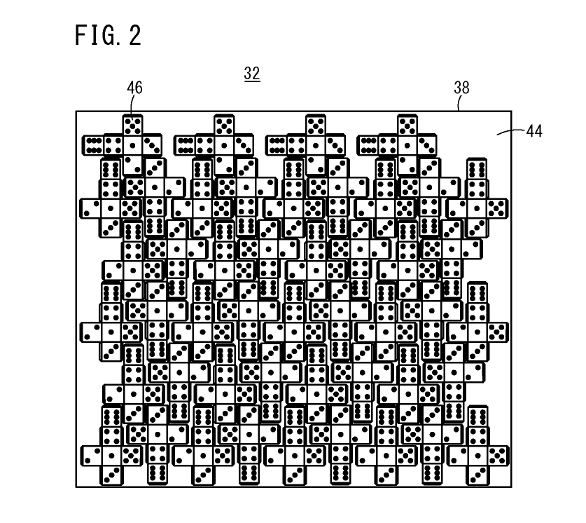

FIG. 2 illustrates the print 32 shown in FIG. 1 in front elevation. As shown in FIG. 2, the sheet 38 has a printed surface 44 with many objects 46 of one type ganged thereon. The objects 46 are laid out in different positions and orientations in a highly packed or efficient layout. The objects 46 are disposed in a regular pattern, and hence can be highly efficiently blanked out of the sheet 38.

The objects 46 are not limited to the package blanks 40, but may be applied to any desired products such as labels, seals, coasters, etc., for example. [Electric Arrangement of the Imposition Apparatus 20]

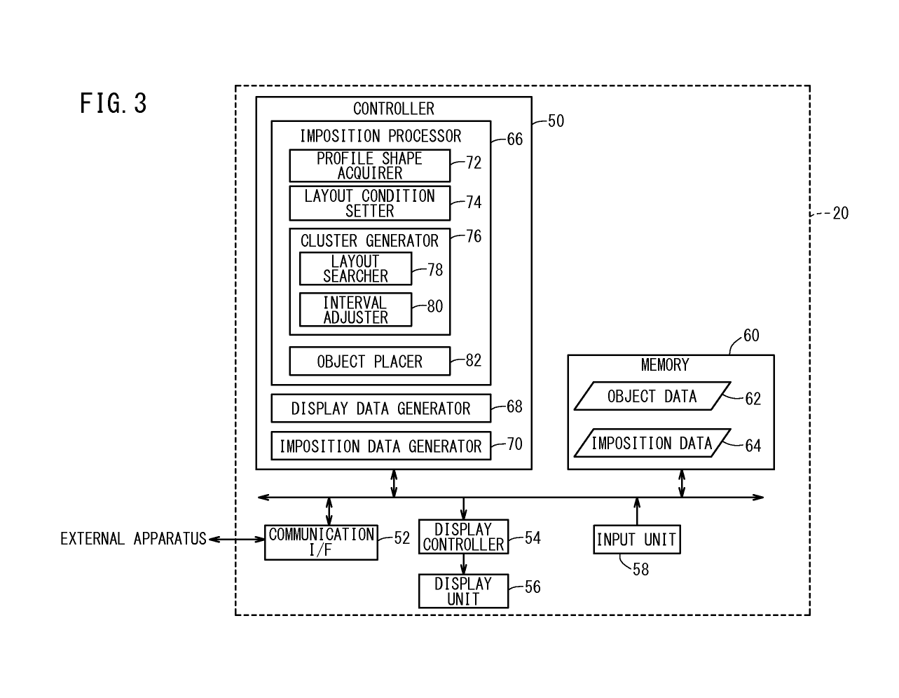

FIG. 3 illustrates the imposition apparatus 20 shown in FIG. 1 in electric block form. As shown in FIG. 3, the imposition apparatus 20 comprises a computer having a controller 50, a communication I/F 52, a display controller 54, a display unit 56, an input unit 58, and a memory 60 (storage medium).

The communication I/F 52 is an interface (I/F) for sending electric signals to and receiving electric signals from external apparatus. The imposition apparatus 20 can acquire object data 62 from the server 16 (FIG. 1) through the communication I/F 52, and can supply imposition data 64 to the server 16 through the communication I/F 52.

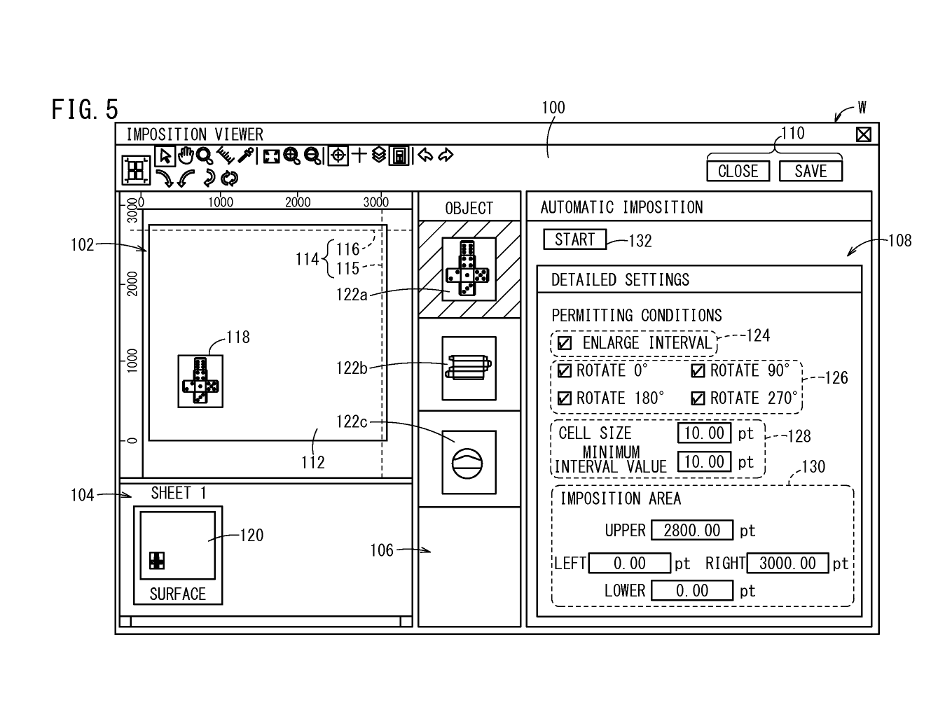

The display controller 54 comprises a control circuit for controlling the display unit 56 under the control of the controller 50. Specifically, in a case where the display controller 54 outputs a display control signal via an I/F, not shown, to the display unit 56, the display unit 56 is energized to display various images including windows W (see FIGS. 5, 16 through 18).

The input unit 58 comprises various input devices including a mouse, a trackball, a keyboard, a touch sensor, etc. The display function of the display unit 56 and the input function of the input unit 58 are combined into a user interface.

The memory 60 stores programs and data which are required for the controller 50 to control various components. In FIG. 3, the memory 60 stores the object data 62 and the imposition data 64.

The memory 60 may comprise a non-transitory, computer-readable storage medium. The computer-readable storage medium comprises a portable medium such as a magnetooptic disk, a ROM, a CD-ROM, or the like, or a storage medium such as a hard disk or the like incorporated in a computer system. The storage medium also includes a medium for dynamically holding programs for a short period of time, or a medium for holding programs for a certain period of time.

The controller 50 comprises a processor such as a CPU (Central Processing Unit). The controller 50 reads and executes programs stored in the memory 60 to perform the functions of an imposition processor 66, a display data generator 68, and an imposition data generator 70.

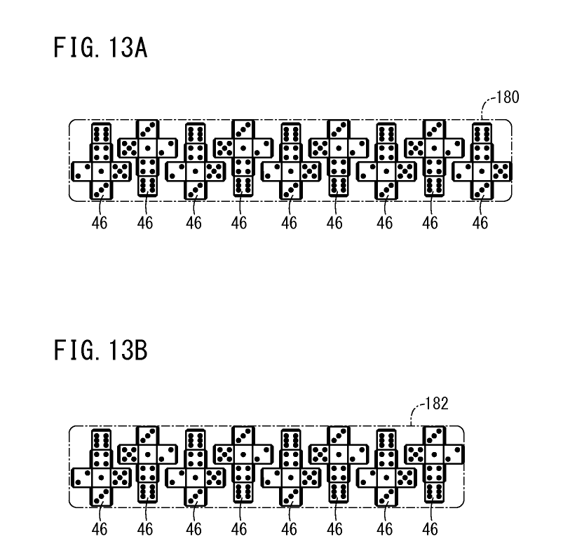

The imposition processor 66 gangs objects 46 of one type in non-overlapping positions in a given area. Specifically, the imposition processor 66 has a profile shape acquirer 72 for acquiring the profile shape of the objects 46, a layout condition setter 74 for setting various conditions (hereinafter referred to as “layout conditions”) about the layout of the objects 46, a cluster generator 76, which includes a layout searcher 78 and an interval adjuster 80, for generating a first object cluster 180 (see FIG. 13A) by laying out the objects 46 according to predetermined layout rules, and an object placer 82 for placing the first object cluster 180, etc. according to predetermined layout rules.

The display data generator 68 generates display data for displaying a window W (see FIGS. 5, 16 through 18) including a setting screen 100 on the display unit 56.

The imposition data generator 70 generates imposition data 64 representing imposition information for the objects 46 ganged by the imposition processor 66.

### [Operation of Imposition Apparatus 20]

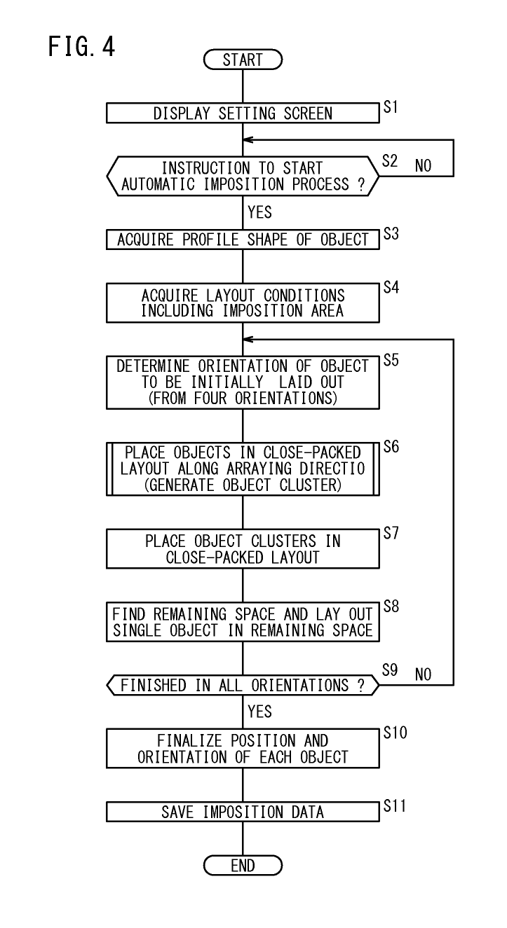

The imposition apparatus 20 as the image editing apparatus according to the present embodiment is constructed as described above. Operation of the imposition apparatus 20 shown in FIGS. 1 and 3 will be described in detail below with reference to a flowchart of FIG. 4.

### <1. Overall Operation (Former Part)>

In step S1 shown in FIG. 4, the imposition apparatus 20 displays a setting screen 100 (see FIG. 5) for use in making automatic imposition settings. Specifically, in response to an instruction to start making settings, the display data generator 68 generates display data for the setting screen 100, and then supplies the generated display data to the display controller 54. The display controller 54 controls the display unit 56 to display a window W including the setting screen 100.

As shown in FIG. 5, the setting screen 100 includes an imposition display field 102, a thumbnail display field 104, an object selection field 106, a condition setting field 108, and a button group 110 having buttons indicated as “CLOSE” and “SAVE”. The user of the imposition apparatus 20, also referred to as the operator, can operate the input unit 58 to make various settings mainly through the condition setting field 108.

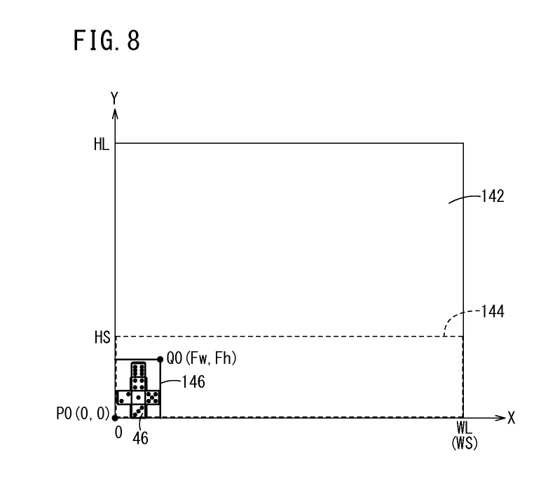

The imposition display field 102 has a rectangular area 112 that simulates the shape of a printing plate 28 or a sheet 38, indication lines 114 including a vertical line 115 and a horizontal line 116 for indicating a rectangular imposition area 142 (FIG. 8), and a single scaled-down image 118.

The thumbnail display field 104 displays therein a thumbnail image 120 corresponding to the rectangular area 112. On the condition that there are a plurality of displayed thumbnail image 120, then the operator may select one of the displayed thumbnail image 120 to call the imposed state of a corresponding sheet in the imposition display field 102.

The object selection field 106 displays scaled-down images 122a, 122b, 122c representing three objects. In FIG. 5, the scaled-down image 122a corresponding to the objects 46 shown in FIG. 2 is selected. The user selects an object 46 to be ganged by dragging the scaled-down image 122a and dropping it at any desired position in the rectangular area 112.

The condition setting field 108 has a check box 124, four check boxes 126, two text boxes 128, four text boxes 130, and a button 132 indicated as “START”. The text boxes 130 are linked with the positions of the indication lines 114.

In step S2, the controller 50 judges whether an instruction to start an automatic imposing process has been entered or not. Specifically, the controller 50 judges whether it has received a click on the “START” button 132 in the condition setting field 108 (FIG. 5) or not. On the condition that the controller 50 has not received a click on the “START” button 132, step S2 is looped until the controller 50 receives a click on the “START” button 132. On the condition that the controller 50 has received a click on the “START” button 132, then control goes to step S3.

In step S3, the profile shape acquirer 72 acquires the profile shape of the object 46 to be ganged. Specifically, the profile shape acquirer 72 reads out object data 62 corresponding to the scaled-down image 118 (FIG. 5) from the memory 60, and thereafter acquires the profile shape of the object 46 to be ganged from the object data 62. The profile shape acquirer 72 may acquire the profile shape according to a process of acquiring ancillary information such as cutting data or the like or a known image processing process including a profile extracting process.

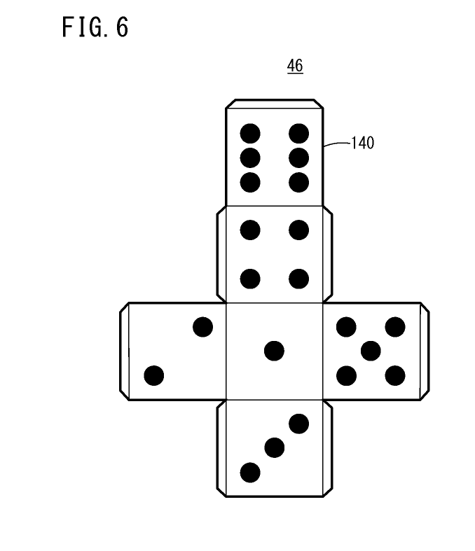

FIG. 6 shows in front elevation the object 46 to be ganged. The object 46 is shown as the development of a package blank 40 which will be assembled into a cube-shape die. In FIG. 6, a profile line 140 represented by the bold line is extracted as the profile shape.

In step S4, the layout condition setter 74 acquires and sets layout conditions for the object 46 that have been entered in the setting screen 100. Specifically, the layout condition setter 74 acquires entered information from the condition setting field 108. As shown in FIG. 5, it is assumed that the layout condition setter 74 has acquired “PERMISSION” for “INCREASE INTERVAL” from the check box 124, and “PERMISSION” for “ROTATE 0°”, “ROTATE 90°”, “ROTATE 180°”, “ROTATE 270°” from the check boxes 126. It is also assumed that the layout condition setter 74 has acquired “10.00”, “10.00” (points, hereinafter referred to as “pt”) from the text boxes 128, and “0.00, 0.00”, “2800.00, 3000.00” (pt) from the text boxes 130.

The orientations “ROTATE 0°” through “ROTATE 270°” as they should be permitted or not represent limiting conditions with respect to the orientation of the object 46. The numerical values “0.00, 0.00”, “2800.00, 3000.00” represent coordinates for specifying the rectangular imposition area 142 (FIG. 8).

The layout condition setter 74 may automatically acquire layout conditions (including limiting conditions) for the object 46, as well as acquiring layout conditions that have manually been entered by the operator. For example, the layout condition setter 74 may determine whether to permit the object 46 to be rotated or not based on various items of information with respect to the grain direction of the sheet 38.

In step S5, the cluster generator 76 determines the orientation of an object 46 to be laid out first. As stated above, since the limiting conditions have been set to permit all the orientations “ROTATE 0°” through “ROTATE 270°”, the cluster generator 76 can determine either one of these four orientations. It is assumed that the cluster generator 76 initially determines the orientation “ROTATE 0°”.

### <2. Detailed Operation of Cluster Generator 76>

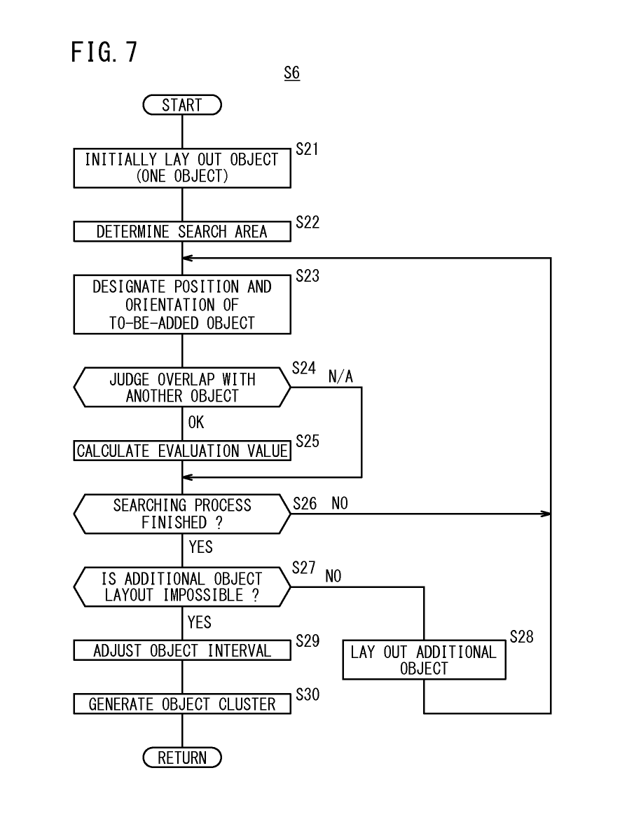

In step S6, the cluster generator 76 lays out a greatest number of objects 46 along an arraying direction to generate a first object cluster 180 (FIG. 13A) or the like. A process of generating a first object cluster 180 or the like (step S6 in FIG. 4) will be described in detail below with reference to a flowchart shown in FIG. 7.

In step S21 shown in FIG. 7, the cluster generator 76 lays out an object 46 in the orientation (0°) determined in step S5 shown in FIG. 4.

In step S22, the cluster generator 76 determines a search area 144, which is an area where objects 46 can be placed, in the rectangular imposition area 142 set in step S4 shown in FIG. 4.

FIG. 8 shows the positional relationship of the imposition area 142 and the search area 144. As shown in FIG. 8, the printing plate 28 or the sheet 38 has a lower left corner defined as an origin O (0, 0), has a horizontal direction defined as an X-axis, and a vertical direction as a Y-axis. The imposition area 142 on the printing plate 28 or the sheet 38 represents a rectangular area having a side along the X-axis which is of a length WL=2800 pt and another side along the Y-axis which is of a length HL=3000 pt.

For example, in step S21, the object 46 is placed in reference to the origin O. Specifically, the object 46 is circumscribed by a rectangular frame that is defined as a circumscribing frame 146, which has a lower left vertex positioned in alignment with the origin O. The vertex which is closest to the origin O will hereinafter be referred to as “vertex PO”, and the vertex of the circumscribing frame 146 which is farthest from the origin O as “vertex Q0”. In FIG. 8, the vertex PO has coordinates (0, 0) and the vertex Q0 has coordinates (Fw, Fh).

The cluster generator 76 determines a length WS of the search area 144 along the X-axis according to the equation (1) below and a length HS of the search area 144 along the Y-axis according to the equation (2) below.

WS=WL (1)

HS=k·Fh (2)

where k is a positive real number that should preferably be generally kept in the range of 1<k<2.

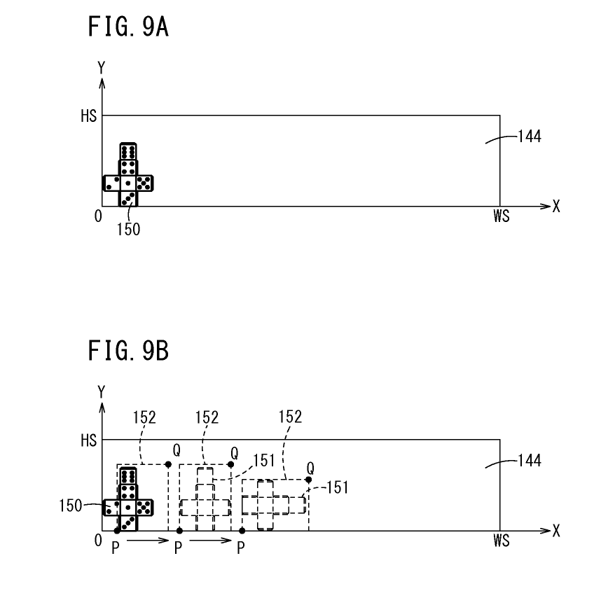

Then, the layout searcher 78 repeats steps S23 through S26, which will be described later, to place objects 46 whose positions and orientations have been determined in the search area 144. For illustrative purposes, an object 46 which has been placed in the search area 144 will be referred to as a laid-out object 150 (see FIG. 9A).

In step S23, the layout searcher 78 designates the position and orientation of an object 46 to be added (hereinafter referred to as “to-be-added object 151”).

FIG. 9B shows a search frame 152 indicated by the broken lines which circumscribes the to-be-added object 151. The size of the search frame 152 is the same as the size of the circumscribing frame 146 (FIG. 8). The vertex of the search frame 152 is closest to the origin O will hereinafter be referred to as “vertex P”, and the vertex of the search frame 152 which is farthest from the origin O as “vertex Q”. In subsequent steps, it is assumed that both the vertexes P, Q are positioned within the search area 144.

In step S24, the layout searcher 78 makes a judgment about an overlap between the to-be-added object 151 whose position and orientation have been designated in step S23 and at least one laid-out object 150. According to the present embodiment, a binary image represented by Boolean values assigned to respective cells C divided as mesh openings is used to indicate whether an object 46 which covers a laid-out object 150 and a to-be-added object 151 is present or not.

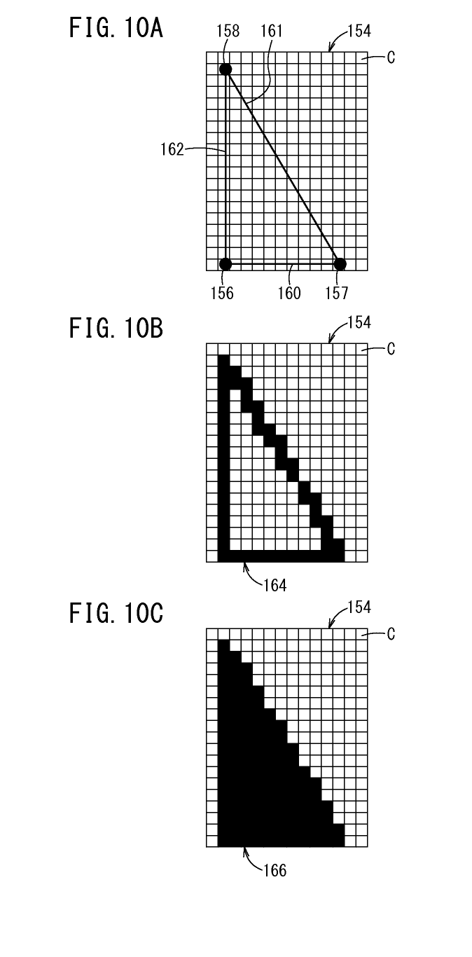

A specific process of rendering an object 46 will be described below with reference to FIGS. 10A through 10C. In FIGS. 10A through 10C, a working area 154 that simulates the search area 144 is introduced. The working area 154 is made up of a plurality of cells C divided as mesh openings which are shown as square in shape. The size of each of the cells C is determined by an input value (10 pt in FIG. 5) that has been entered in one of the text boxes 128.

As shown in FIG. 10A, it is assumed that a triangular object, not shown, is placed in a position defined by three vertexes 156, 157, 158 in the working area 154. FIG. 10A shows, together with the three vertexes 156, 157, 158, a side 160 interconnecting the vertexes 156, 157, a side 161 interconnecting the vertexes 157, 158, and a side 162 interconnecting the vertexes 156, 158.

The sides 160, 161, 162 are rendered by Boolean values assigned to respective cells C. Specifically, a value “TRUE (=1)” is assigned to each of the cells C where the sides 160, 161, 162 are present, and a value “FALSE (=0)” is assigned to each of the cells C where the sides 160, 161, 162 are not present. As a result, a pattern 164 is generated in the working area 154, as shown in FIG. 10B. Those cells C which are shown as filled indicate that their values are “TRUE”, and those cells C which are shown as blank indicate that their values are “FALSE”.

On the condition that there is a closed region surrounded by the cells C whose values are “TRUE”, all the values of the cells C that are positioned within the closed region are replaced with the value “TRUE”, thereby generating a pattern 166 in the working area 154, as shown in FIG. 10C. The pattern 164 shown in FIG. 10B represents the profile of an object, whereas the pattern 166 shown in FIG. 10C represents the shape of the object.

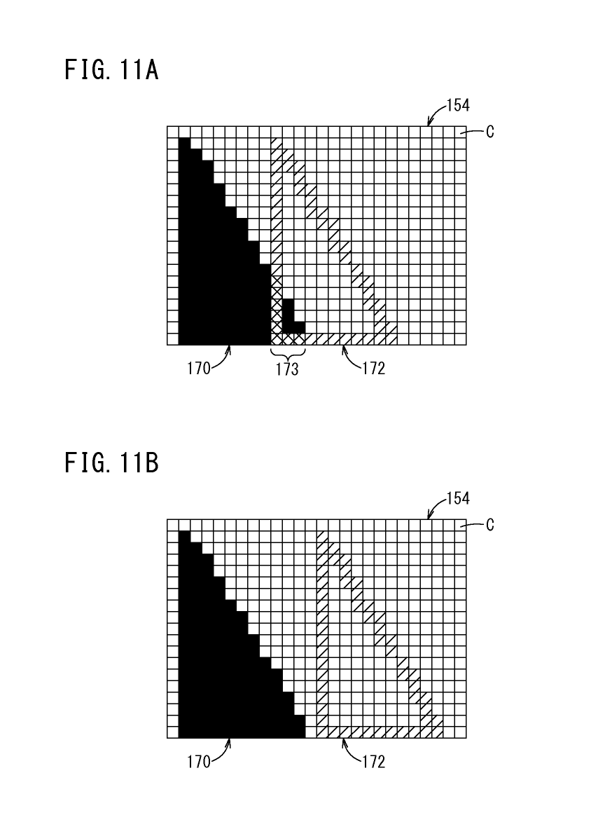

Based on the binary image thus generated, the layout searcher 78 makes a judgment about an overlap between objects. A specific process of making a judgment about an overlap between objects which are assumed to be triangular in shape as is the case with the object shown in FIGS. 10A through 10C will be described below with reference to FIGS. 11A and 11B.

As shown in FIGS. 11A and 11B, a pattern 170, which is represented by a cluster of cells C shown as filled, corresponding to a laid-out object, is positioned in the working area 154. The layout searcher 78 generates a pattern 172, which is represented by a cluster of cells C shown as single-line-hatched, corresponding to a to-be-added object, and judges whether the pattern 172 overlaps the pattern 170 or not, with respect to each of the cells C of the pattern 172. Specifically, the layout searcher 78 judges “OK (CAN BE LAID OUT)” on the condition that the value of a cell C to be judged is “FALSE”, and judges “N/A (CANNOT BE LAID OUT)” on the condition that the value of a cell C to be judged is “TRUE”.

In FIG. 11A, since the patterns 170, 172 overlap each other in an overlapping range 173, which is represented by a cluster of cells C shown as cross-line-hatched, the layout searcher 78 judges that the to-be-added object cannot be laid out (N/A). In FIG. 11B, since the patterns 170, 172 do not overlap each other, the layout searcher 78 judges that the to-be-added object can be laid out (OK).

As the layout searcher 78 makes a judgment about an overlap between the laid-out object 150 and the to-be-added object 151 using binary images, the amount of processing and the storage capacity of the memory required for making such a judgment are greatly reduced. The amount of processing is further reduced because at least one of laid-out object 150 and the to-be-added object 151 is rendered as a profile pattern in the working area 154.

The object 46 shown in FIG. 6 is of a more complex shape than the triangular shape described above. For processing the object 46 shown in FIG. 6, feature points, e.g., vertexes or inflection points, on the profile of the object 46 are extracted, and adjacent ones of the feature points are interconnected by straight lines, thereby approximating the profile of the object 46. The judging process described above with reference to FIGS. 10A through 11B is applicable to the profile thus approximated.

The processing accuracy and the processing time can be changed by changing the value of “CELL SIZE” in one of the text boxes 128 (FIG. 5). Specifically, the processing accuracy increases in a case where the value of “CELL SIZE” is reduced, and the processing time is shortened in a case where the value of “CELL SIZE” is increased.

On the condition that the value of “MINIMUM INTERVAL” in the other one of the text boxes 128 (FIG. 5) is set to a value other than 0, then an overlap can be judged strictly. In FIG. 5, both the values of “CELL SIZE” and “MINIMUM INTERVAL” are 10 pt, the layout searcher 78 judges “OK” in step S24 on the condition that the interval between cells C is 1 (=minimum interval/cell size) or greater.

The layout searcher 78 makes a judgment about an overlap between the to-be-added object 151 and at least one laid-out object 150 according to the above process. On the condition that the layout searcher 78 judges “N/A” in step S24, then control skips step S25 and jumps to step S26. On the condition that the layout searcher 78 judges “OK” in step S24, then control goes to step S25.

In step S25, the layout searcher 78 calculates an evaluation value E with respect to the layout of the to-be-added object 151. Specifically, the layout searcher 78 calculates an evaluation value E according to the following equation (3):

E=x·y (3)

where x, y represent the coordinates of the vertex Q of the search frame 152.

As can be seen from the equation (3), the evaluation value E tends to be smaller on the condition that the vertex Q is closer to the origin O or closer to the X-axis or the Y-axis. The evaluation value E thus serves as an index for quantifying the extent to which objects are placed in a close-packed layout along the arraying direction.

The evaluation value E may be calculated using both of or either one of various parameters and evaluation functions, rather than the equation (3). The calculated evaluation value E is temporarily stored in the memory 60 in association with the position and orientation of the to-be-added object 151.

In step S26 shown in FIG. 7, the layout searcher 78 judges whether the searching process in the search area 144 has been finished or not. On the condition that the layout searcher 78 judges that the searching process has not been finished, then control goes back to step S23 for the layout searcher 78 to repeat steps S23 through S26. Specifically, while successively changing both of or either one of the coordinates of the vertex P and the orientation of the search frame 152 in FIG. 9B, the layout searcher 78 judges [1] whether the search frame 152 falls in the search area 144 or not and judges [2] whether there is an overlap between the to-be-added object 151 and the laid-out object 150 or not. On the condition that the layout searcher 78 judges that the searching process in the search area 144 has been finished, then control goes to step S27.

In step S27, the layout searcher 78 judges whether it is impossible to lay out a to-be-added object 151 or not based on the result of the searching process. For example, the layout searcher 78 can judge whether it is impossible to lay out a to-be-added object 151 or not based on the number of times that step S25 is carried out, i.e., the evaluation value E is calculated, in the searching process. On the condition that step S25 has been carried out at least once, then it is possible to lay out a to-be-added object 151 (step S27: NO), and control goes to step S28.

In step S28, the layout searcher 78 selects a set of a position and an orientation whose evaluation value E is minimum from among at least one set of the position and the orientation temporarily stored in the memory 60, and adds and lays out one object 46.

Thereafter, control goes back to step S23, for the layout searcher 78 to repeat steps S23 through S26 with one laid-out object 150 being added. As the layout searcher 78 successively lays out objects 46 along the arraying direction, i.e., along the X-axis in the embodiment, thereby incrementing the number of laid-out objects 150 one by one.

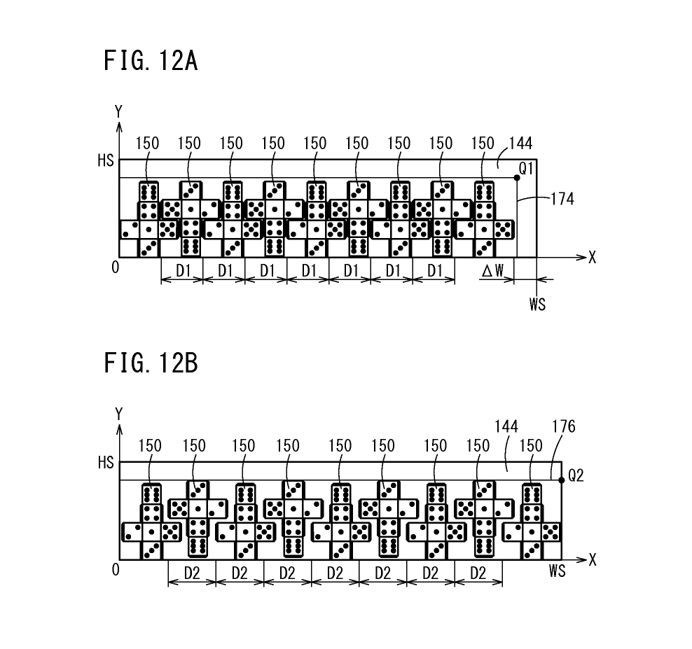

FIG. 12A is a view showing the positional relationship of laid-out objects 150 placed in a close-packed layout along the X-axis. It should be understood that the “close-packed layout” means an optimum solution achieved by the calculations according to a layout optimizing algorithm, but not a theoretically exact solution.

As shown in FIG. 12A, the laid-out objects 150 are placed complementarily with their orientations changed to 0°, 180°, 0°, 180°, . . . . Consequently, a greatest number of laid-out objects 150 are present in the search area 144. A circumscribing frame 174 represents a rectangular frame that circumscribes a single cluster of nine laid-out objects 150.

Of the four vertexes of the circumscribing frame 174, the vertex that is farthest from the origin O is referred to as “vertex Q1”. The vertex Q1 has an X-coordinate (WS−ΔW), with D1>ΔW being satisfied where D1 corresponds to a substantial interval between adjacent two of the laid-out objects 150. In the searching process at steps S23 through S26, step S25 (calculation of the evaluation value E) may not be carried out even once.

On the condition that step S25 is not carried out even once, then the layout searcher 78 judges that it is impossible to lay out a to-be-added object 151 (S27: YES), after which control goes to step S29.

In step S29, the interval adjuster 80 adjusts the intervals along the X-axis between the laid-out objects 150 as necessary. Specifically, the interval adjuster 80 uniformly widens the intervals D1 insofar as each of the intervals does not exceed the length WS of one side of the search area 144. The interval adjuster 80 adjusts the intervals in a case where the check box 124 (FIG. 5) is ticked, and does not adjust the intervals in a case where the check box 124 is not ticked.

FIG. 12B is a view showing that the laid-out objects 150 in FIG. 12A have been spaced apart at the uniformly widened intervals. A circumscribing frame 176 represents a rectangular frame that circumscribes a single cluster of nine laid-out objects 150. Of the four vertexes of the circumscribing frame 176, the vertex that is farthest from the origin O is referred to as “vertex Q2”.

As understood from FIGS. 12A and 12B, the circumscribing frame 176 is greater than the circumscribing frame 174 by ΔW along the X-axis, and the vertex Q2 has an X coordinate WS. A substantial interval D2 between adjacent two of the laid-out objects 150 is represented by D2=D1+ΔW/7. The effect of the interval adjusting process will be described later.

In step S30, the cluster generator 76 generates a first object cluster 180 and a second object cluster 182 from the laid-out objects 150 the intervals between which have been adjusted in step S29.

FIG. 13A shows the first object cluster 180 in front elevation. The first object cluster 180 is identical to the cluster of laid-out objects 150 that is present in the circumscribing frame 176 (FIG. 12B). Specifically, the first object cluster 180 is made up of a greatest number of objects 46 laid-out along the arraying direction so that they do not exceed the length WL of one side of the imposition area 142 (FIG. 8).

FIG. 13B shows the second object cluster 182 in front elevation. The second object cluster 182 is generated by deleting an endmost object 46, i.e., an object 46 at the right end, from the first object cluster 180.

The cluster generator 76 thus generates the first object cluster 180 (FIG. 13A) and the second object cluster 182 (FIG. 13B) by laying out objects 46 of one type which have a desired shape according to predetermined layout rules (step S6 in FIG. 4).

The cluster generator 76 may use Boolean values assigned to respective cells C divided as mesh openings to indicate whether each object 46 to be laid out is present or not, thus generating a binary image, make a judgment about an overlap between objects 46 based on the binary image thus generated, and generate a first object cluster 180 such that the objects 46 will not overlap each other.

The layout condition setter 74 may further set limiting conditions with respect to the orientations of objects 46. In this case, the cluster generator 76 generates a first object cluster 180 according to the limiting conditions thus set.

### <3. Overall Operation (Latter Part)>

Operation of the imposition apparatus 20 shown in FIGS. 1 and 3 will be described in detail with reference to the flowchart shown in FIG. 4.

In step S7 shown in FIG. 4, the object placer 82 lays out a cluster made up of the greatest number of objects 46, i.e., the first object cluster 180 or the second object cluster 182, in the imposition area 142. At this time, the same process of searching for an object layout as the process (see FIGS. 8 through 9B) performed by the cluster generator 76 may be employed. Furthermore, the same process of making a judgment about an overlap as the process (see FIGS. 10A through 11B) performed by the cluster generator 76 may be employed. The object placer 82 uses Boolean values assigned to respective cells C divided as mesh openings to indicate whether each object 46 to be laid out is present or not, thus generating a binary image, makes a judgment about an overlap between objects 46 based on the binary image thus generated, and lays out the first object cluster 180 or the second object cluster 182 such that the objects 46 will not overlap each other.

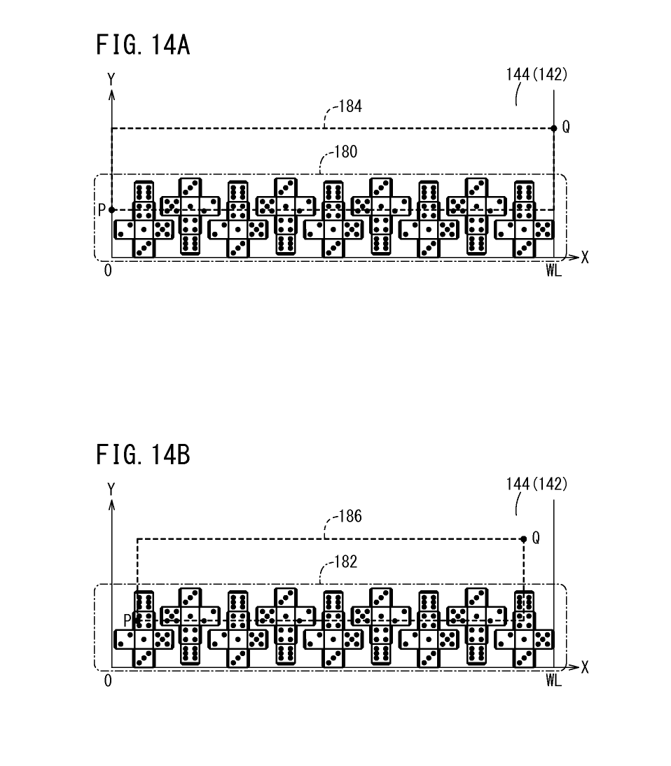

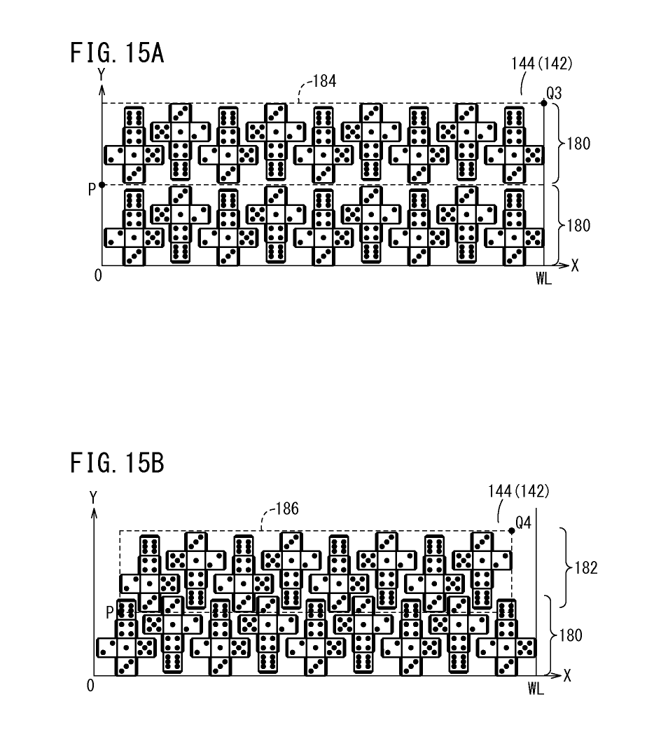

Specific details of operation of the object placer 82 will be described below with reference to FIGS. 14A through 15B. The imposition area 142 is established in its entirety as the search area 144.

The object placer 82 initially places the first object cluster 180 in reference to the origin O. Then, the object placer 82 successively performs: (1) a close-packed laying-out process for the first object cluster 180 as an object cluster to be added; and (2) a close-packed laying-out process for the second object cluster 182 as an object cluster to be added.

As shown in FIG. 14A, the object placer 82 searches for a layout for the first object cluster 180 while designating the position and orientation of the first object cluster 180 as an object cluster to be added. The position of the first object cluster 180 is designated using a rectangular search frame 184 that circumscribes the first object cluster 180. The orientation of the first object cluster 180 is either 0° or 180°. The object placer 82 then determines one set of a position and an orientation whose evaluation value E according to the equation (3) is minimum, in the same manner as with step S6 in FIG. 7.

As shown in FIG. 14B, the object placer 82 searches for a layout for the second object cluster 182 while designating the position and orientation of the second object cluster 182 as an object cluster to be added. The position of the second object cluster 182 is designated using a rectangular search frame 186 that circumscribes the second object cluster 182. The orientation of the second object cluster 182 is either 0° or 180°. The object placer 82 then determines one set of a position and an orientation whose evaluation value E according to the equation (3) is minimum, in the same manner as with step S6 in FIG. 7.

FIG. 15A shows the two first object clusters 180 that have been placed in a close-packed layout. Of the four vertexes of the circumscribing frame 184, the vertex that is closest to the origin O is referred to as “vertex P” and the vertex that is farthest from the origin O is referred to as “vertex Q3”.

FIG. 15B shows the first object cluster 180 and the second object cluster 182 that have been placed in a close-packed layout. Of the four vertexes of the circumscribing frame 186, the vertex that is closest to the origin O is referred to as “vertex P” and the vertex that is farthest from the origin O is referred to as “vertex Q4”.

As can be understood from FIGS. 15A and 15B, the evaluation value E at the vertex Q4 is smaller than the evaluation value E at the vertex Q3. Thus, the object placer 82 determines that the second object cluster 182 is to be laid out at the position of the search frame 186.

By using not only the first object cluster 180 but also the second object cluster 182, it is possible to search for a close-packed layout along the Y-axis. Furthermore, widening the intervals between the objects 46 (step S29 in FIG. 7, see FIG. 14B), it is highly possible to lay out the objects 46 closely along the Y-axis. Particularly, while the greatest number of objects 46 are placed in a close-packed layout, the intervals D1 between the objects 46 along the arraying direction should preferably be uniformly increased insofar as each of the intervals does not exceed the length WS of one side of the imposition area 142.

Thereafter, the object placer 82 similarly lays out as many first object clusters 180 or second object clusters 182 as possible in the imposition area 142 as the search area 144 (step S7). For placing the objects 46 of the illustrated shape, the object placer 82 lays out first object clusters 180 and second object clusters 182 alternately along the Y-axis.

In step S8, the object placer 82 finds a remaining space in the imposition area 142 after the first object clusters 180, etc. have already been laid out in step S7, and then lays out as many objects 46 as possible in the remaining space.

In step S9, the imposition processor 66 judges whether layout trials for all orientations have been finished with respect to the object 46 to be initially laid out or not. On the condition that the imposition processor 66 judges that the layout trials for all orientations have not been finished, then control goes back to step S5 in which an unselected orientation, i.e., one of 90°, 180°, and 270°, is selected, and then steps S5 through S8 are repeated. On the condition that the imposition processor 66 judges that the layout trials for all orientations have been finished, then control goes to step S10.

In step S10, the imposition processor 66 finalizes the position and orientation of each object 46 based on the processing results in step S3 through S9. The layout results for the objects 46 have been obtained with respect to each of the four orientations for initial layouts. For example, the imposition processor 66 may select one of the layout results based on the total number of layouts, the evaluation results E, or the priority of orientations of the objects 46, thereby finalizing the position and orientation of each object 46.

Thereafter, the imposition apparatus 20 updates the setting screen 100 displayed for making automatic imposition settings. In a case where the position and orientation of each object 46 is finalized, the display data generator 68 updates the display data for the setting screen 100 and then supplies the updated display data to the display controller 54. The display controller 54 controls the display unit 56 to display a window W including the setting screen 100.

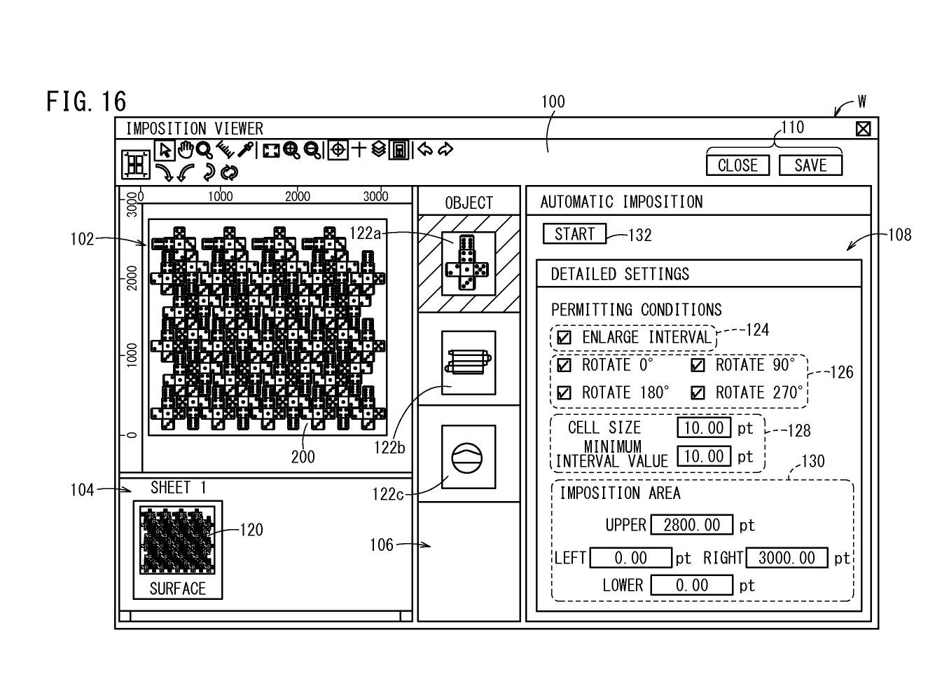

The setting screen 100 shown in FIG. 16 is different from the setting screen 100 shown in FIG. 5 as to the display format of the imposition display field 102. Specifically, the imposition display field 102 has an image area 200 that simulates a ganged object pattern on the printing plate 28 or the sheet 38, instead of the rectangular area 112. The operator visually checks the ganged object pattern presented in the image area 200 to determine whether the ganged object pattern is acceptable or not. In response to the operator pressing the “SAVE” button in the button group 110 on the setting screen 100, control goes to step S11 shown in FIG. 4.

In step S11, the imposition data generator 70 generates imposition data 64 representing imposition information that specifies the position and orientation of each object 46 that is finalized in step S10, and stores and saves the imposition data 64 in the memory 60. Thereafter, the imposition apparatus 20 may send the imposition data 64 through the communication I/F 52 to the server 16 in order to save the imposition data 64 in the server 16.

### <4. Other Imposition Examples>

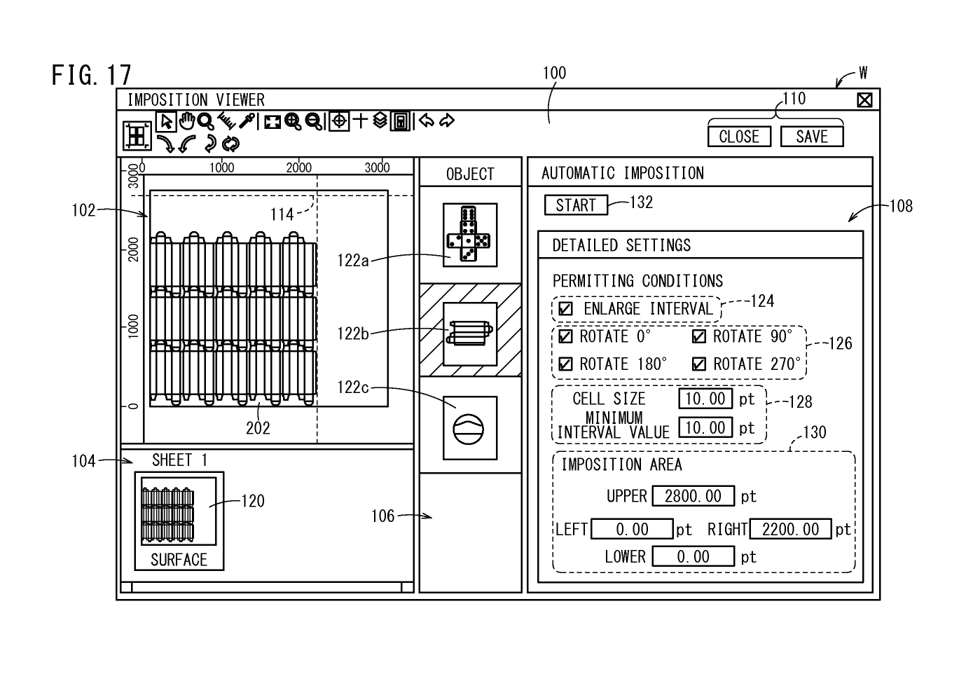

The above ganging process is applicable to objects having other shapes. For example, it is assumed that another object, which represents the development of a box (the form of a rectangular parallelepiped), corresponding to the scaled-down image 122b, is selected and coordinates (0.00, 0.00), (2200.00, 2800.00) are established as representing the imposition area 142. In this case, another image area 202 is placed in the imposition display field 102 on the setting screen 100 shown in FIG. 17.

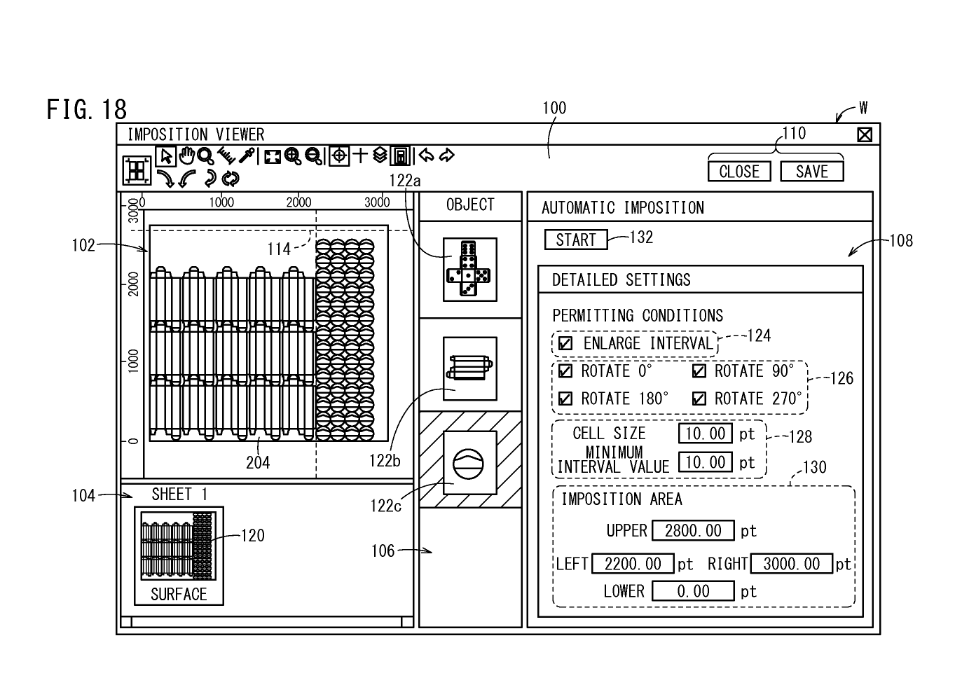

Thereafter, it is assumed that another object, which represents a circular coaster, corresponding to the scaled-down image 122c, is selected and coordinates (2200.00, 0.00), (2800.00, 3000.00) are established as representing the imposition area 142. In this case, another image area 204 is placed in the imposition display field 102 on the setting screen 100 shown in FIG. 18. As shown in FIG. 18, one imposition area may be divided into two or more subareas, and the above ganging process may be performed in each of the subareas.

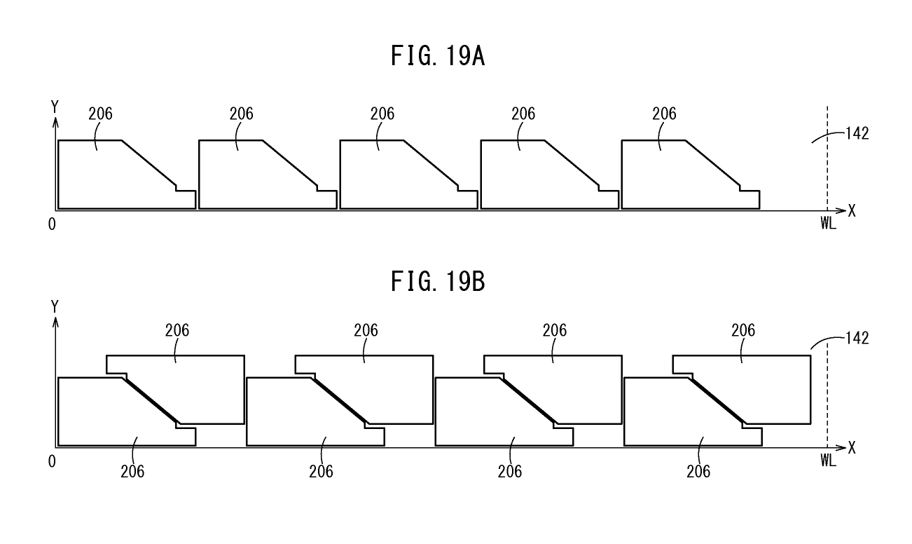

The above ganging process may also be applied to objects 206 that are designed with almost no concern about the efficiency with which to lay out the objects. FIGS. 19A and 19B show objects 206 each having a substantially hexagonal profile that is produced by cutting off a corner of a rectangular shape to provide a trapezoidal shape.

FIG. 19A shows a layout of objects 206 oriented in one direction. FIG. 19B shows a layout of objects 206 that have been placed in a close-packed layout by the image processing method according to the embodiment. As can be seen from FIGS. 19A and 19B, the layout shown in FIG. 19B is of a higher efficiency, i.e., a higher layout area ratio, than the layout shown in FIG. 19A. According to the present embodiment, therefore, objects 206 having a desired shape can be placed in a close-packed layout.

### ADVANTAGES OF THE PRESENT EMBODIMENT

As described above, the imposition apparatus 20 is an apparatus for ganging objects 46 of one type in non-overlapping positions on the printing plate 28 or the print medium 38.

The imposition apparatus 20 includes the profile shape acquirer 72 for acquiring the profile shape (profile line 140) of the objects 46, the layout condition setter 74 for setting the rectangular imposition area 142 on the printing plate 28 or the print medium 38, the cluster generator 76 for generating the first object cluster 180 by laying out the greatest number of objects 46 along the arraying direction (X-axis) such that the objects 46 do not exceed the length (WL) of one side of the imposition area 142, based on the acquired profile shape, and the object placer 82 for placing the greatest number of first object clusters 180 along the direction (Y-axis) of another side, extending across the one side, of the imposition area 142 such that the first object clusters 180 do not exceed the length (HL) of the other side, based on the shape of the first object cluster 180.

The imposition apparatus 20 thus arranged is capable of performing a two-dimensional layout process for objects 46 by dividing the two-dimensional layout process into two times of separate one-dimensional layout processes. Consequently, the processing time required to carry out the two-dimensional layout process can greatly be reduced. Furthermore, since the objects 46 are laid out using the first object cluster 180 or the second object cluster 182 as a basic unit, the objects 46 that make up the first object cluster 180 or the second object cluster 182 have their relative positional relationship and regularity maintained at all times. Therefore, objects 46 which have any desired shape can be ganged efficiently in terms of layout space, processing time, and blanking.

The present invention is not limited to the illustrated embodiment, but many changes and modifications can be made to the embodiment without departing from the scope of the present invention.

What is claimed is:

1. An image editing apparatus for ganging objects of one type in non-overlapping positions on a printing plate or a print medium, comprising:
a profile shape acquirer for acquiring a profile shape of the objects;
a layout condition setter for setting a rectangular imposition area on the printing plate or the print medium;
a cluster generator for generating a first object cluster by laying out a greatest number of objects along an arraying direction such that the objects do not exceed a length of one side of the imposition area set by the layout condition setter, based on the profile shape acquired by the profile shape acquirer; and
an object placer for placing a greatest number of first object clusters along a direction of another side, extending across the one side, of the imposition area such that the first object clusters do not exceed a length of the other side, based on a shape of the first object cluster generated by the cluster generator.

2. The image editing apparatus according to claim 1, wherein the cluster generator generates the first object cluster by uniformly widening an interval along the arraying direction between the objects such that the objects do not exceed the length of the one side, while the greatest number of objects are being placed in a close-packed layout.

3. The image editing apparatus according to claim 2, wherein the cluster generator further generates a second object cluster by deleting an endmost object from the first object cluster; and
the object placer lays out the first object cluster and the second object cluster alternately along the direction of the other side.

4. The image editing apparatus according to claim 3, wherein the object placer uses Boolean values assigned to respective cells divided as mesh openings to indicate whether each of the objects to be laid out is present or not, thus generating a binary image, makes a judgment about an overlap between the objects based on the binary image thus generated, and lays out the first object cluster or the second object cluster such that the objects will not overlap each other.

5. The image editing apparatus according to claim 1, wherein the cluster generator uses Boolean values assigned to respective cells divided as mesh openings to indicate whether each of the objects to be laid out is present or not, thus generating a binary image, makes a judgment about an overlap between the objects based on the binary image thus generated, and generates the first object cluster such that the objects will not overlap each other.

6. The image editing apparatus according to claim 1, wherein the layout condition setter sets a limiting condition with respect to an orientation of the objects; and
the cluster generator generates the first object cluster according to the limiting condition set by the layout condition setter.

7. An image editing method of ganging objects of one type in non-overlapping positions on a printing plate or a print medium, the method being performed by a computer and comprising the steps of:
acquiring a profile shape of the objects;
setting a rectangular imposition area on the printing plate or the print medium;
generating an object cluster by laying out a greatest number of objects along an arraying direction such that the objects do not exceed a length of one side of the imposition area which is set, based on the profile shape which is acquired; and
placing a greatest number of first object clusters along a direction of another side, extending across the one side, of the imposition area such that the first object clusters do not exceed a length of the other side, based on a shape of the object cluster which is generated.

8. The image editing method according to claim 7, wherein the step of generating generates the first object cluster by uniformly widening an interval along the arraying direction between the objects such that the objects do not exceed the length of the one side, while the greatest number of objects are being placed in a close-packed layout.

9. The image editing method according to claim 8, wherein the step of generating generates a second object cluster by deleting an endmost object from the first object cluster; and
the step of placing lays out the first object cluster and the second object cluster alternately along the direction of the other side.

10. The image editing method according to claim 9, wherein the step of placing uses Boolean values assigned to respective cells divided as mesh openings to indicate whether each of the objects to be laid out is present or not, thus generating a binary image, makes a judgment about an overlap between the objects based on the binary image thus generated, and lays out the first object cluster or the second object cluster such that the objects will not overlap each other.

11. The image editing method according to claim 7, wherein the step of generating uses Boolean values assigned to respective cells divided as mesh openings to indicate whether each of the objects to be laid out is present or not, thus generating a binary image, makes a judgment about an overlap between the objects based on the binary image thus generated, and generates the first object cluster such that the objects will not overlap each other.

12. The image editing method according to claim 7, wherein the step of setting sets a limiting condition with respect to an orientation of the objects; and
the step of generating generates the first object cluster according to the limiting condition which is set.

13. A non-transitory storage medium storing a program for ganging objects of one type in non-overlapping positions on a printing plate or a print medium, wherein the program controls a computer to perform the steps of:
acquiring a profile shape of the objects;
setting a rectangular imposition area on the printing plate or the print medium;
generating an object cluster by laying out a greatest number of objects along an arraying direction such that the objects do not exceed a length of one side of the imposition area which is set, based on the profile shape which is acquired; and
placing a greatest number of first object clusters along a direction of another side, extending across the one side, of the imposition area such that the first object clusters do not exceed a length of the other side, based on a shape of the object cluster which is generated.
